(19) United States
(12) Patent Application Publication
(10) Pub. No.: US 2006/0106718 A1
(43) Pub. Date: May 18, 2006

(54) Electronic chain of custody method and system

(75) Inventors: Peter Spellman, Quincy, MA (US); Shabbir Dahod, Andover, MA (US); Lucia Deus, Bedford, MA (US); Craig Leckband, Bedford, MA (US); Sean Wellington, Newton, MA (US)

Correspondence Address: WILMER CUTLER PICKERING HALE AND DORR LLP, 60 STATE STREET, BOSTON, MA, 02109, US

(73) Assignee: SupplyScape Corporation, Cambridge, MA (US)

(21) Appl. No.: 10/989,956

(22) Filed: Nov. 16, 2004

(51) Int. Cl. G06Q 99/00; H04L 9/00; H04K 1/00

(52) U.S. Cl. 705/50

(57) ABSTRACT

Methods and systems are provided for maintaining a chain of custody record for the handling of an item transferred among a plurality of custodians. A system in accordance with one or more embodiments can include a plurality of computers operable by the custodians. The system also includes an electronic form transferable among the computers. The form is transferred from a computer operated by one custodian to a computer operated by another in correspondence with the transfer of the item from the custodian to the other. The form identifies the item and includes space for entry of information by each custodian handling the item. The information entered by the custodians includes an identification of the custodian and a digital signature of the custodian authenticating the item. At least some of the information entered by a custodian is unalterable by another custodian.

### FIELD OF THE INVENTION

The present invention relates generally to maintaining a chain of custody record for the handling of physical items and, more particularly, to an electronic chain of custody record that provides a verifiable record of item handling.

### BACKGROUND OF THE INVENTION

Chain of custody records can be used for tracking and tracing the movement of an item in a supply chain, and for authenticating the item as it is transferred in the chain. A system that can accurately maintain chain of custody records can be particularly useful to inhibit the distribution of counterfeit products in the supply chain.

### BRIEF SUMMARY OF EMBODIMENTS OF THE INVENTION

The present invention is generally directed to methods and systems for maintaining a chain of custody record for the handling of an item transferred among a plurality of custodians, e.g., in a product supply chain. In accordance with one or more embodiments of the invention, an electronic form that can be transferred from custodian to custodian provides a record of the chain of custody. The form can be successively transferred from a computer operated by one custodian to a computer operated by another corresponding to the successive transfer of the item from the custodian to the other. The form identifies the item that is transferred and includes space for entry of information by each custodian handling the item. The information entered by the custodians includes an identification of the custodian and a digital signature of the custodian authenticating the item. At least some of the information entered by a custodian is unalterable by another custodian receiving the form.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a simplified block diagram illustrating an exemplary supply chain in the pharmaceutical industry;

FIG. 2 is a simplified block diagram generally illustrating the process of maintaining a chain of custody record for the handling of a drug product in accordance with one or more embodiments of the invention; and

FIG. 3 is a screen shot of an exemplary electronic form in accordance with one or more embodiments of the invention.

### DETAILED DESCRIPTION OF PREFERRED EMBODIMENTS

The present invention is generally directed to methods and systems for maintaining electronic, certified chain of custody records for physical items or articles like products, materials or objects. (The term “item” is broadly used herein to include single or multiple products, materials, or objects.) Briefly, in accordance with one or more embodiments of the invention, the certified chain of custody is in the form of a transferable electronic document or file that provides a verifiable record of the chain of custody for the handling of the item. The electronic document or file can reside on and is successively transferable among computer systems operable by custodians of the items.

The chain of custody file references items in the physical world, which are linked to the chain of custody file by unique identifiers such as, e.g., serial numbers. The serial number or other identifier can be indicated or stored on the item itself or on a container or packaging for the item and can be read by visual inspection or using various sensing mechanisms including bar code readers and Radio Frequency Identification (RFID) systems and other automatic data capture technologies.

The chain of custody file contains information about the item referenced. This information can be used to help identify or verify (i.e., authenticate) the item or to provide computer systems processing the chain of custody more information about the item.

In accordance with one or more embodiments of the invention, the chain of custody file can contain information about the context of the change in custody. This information can include who the custodians are, their organizations and roles, date/time, reason for the change in custody and other information pertinent to the change of custody (including, e.g., whether it is a sale, transfer, return etc.). Depending on the chain of custody scenario, this information can vary from application to application as desired.

In accordance with one or more embodiments of the invention, the chain of custody file can be certified using digital signatures. Each custodian successively signs the entire chain of custody file (verifying, e.g., item information, information about the context of each change in custody), including the previous custodians' information. Preferably, no part of the chain of custody file can be modified or substituted by subsequent parties.

Custodians can certify the chain of custody file by digitally signing it when the item leaves their custody. In addition, in accordance with one or more embodiments of the invention, custodians can optionally also certify the chain of custody by digitally signing it when associated items come into their custody.

The chain of custody file can also include references to the business documentation for changes in custody as part of the context of change of custody, which may be used to get more detailed information on the transaction from other sources or systems (e.g., an invoice number).

In accordance with one or more embodiments of the invention, the chain of custody file is a document-based electronic form. The document can be routed (either using, e.g., computers on a network or removable media) successively from custodian to custodian for processing, enabling each custodian to have their own document of record for the chain of custody, secured by the digital signatures. Examples of networks that can be used to transfer the form include the Internet, Intranets, LANs, WANs, and other computer networks. In accordance with one or more embodiments of the invention, a copy of the chain of custody document can also be sent to interested parties and/or to a central authority for processing or monitoring.

In accordance with one or more embodiments of the invention, the chain of custody file can be validated at any time by processing the digital signatures. This ensures that the chain of custody file is valid at any time, and especially at the time of a change in custody (when new digital signatures are being added).

In accordance with one or more embodiments of the invention, prior to receipt of the item or items referenced in the chain of custody, the chain of custody document can be sent to the recipient and verified electronically to ensure its validity up to the point of their receipt.

A chain of custody file can be created at any time where the custodial history must be maintained. This could be, e.g., when the item is manufactured or when the item comes into an environment requiring that the chain of custody be maintained.

In accordance with one or more embodiments of the invention, the chain of custody file is maintainable and verifiable within and across organizations. Each custodian can retain a copy of the chain of custody file for his or her own records.

The custodian can be, e.g., an individual, role or organization. The level of accountability can be influenced by the granularity of the custodian, e.g., individuals are generally more accountable than roles.

In accordance with one or more embodiments of the invention, disposition of item for the change of custody (what the item referenced by the chain of custody is intended to be used for) can also be included, providing preferably an unalterable record of the purpose for which the item is changing custody. This can be used to help ensure that the item is handled appropriately. For example, if an item is changing hands to be destroyed or recycled, then that disposition can be expressed in the chain of custody. Systems processing the chain of custody can use that information to help comply with the disposition and subsequent attempts to use that chain of custody will show that the item was intended for destruction or recycling and therefore should not be used for another purpose.

A chain of custody system in accordance with one or more embodiments of the invention can have a variety of applications including, but not limited to, use in the pharmaceutical, food, defense, medical devices, electronics, software and music industries, and in maintaining homeland security and controlling imports.

### EXAMPLE 1

### Pharmaceutical Industry

Use of a chain of custody system in accordance with one or more embodiments of the invention in the pharmaceutical industry can streamline secure drug delivery cost-effectively and enable rapid authentication, serialized drug tracking, cost-effective pedigree tracing, precision recalls and reimbursement compliance.

The U.S. pharmaceutical industry loses large sums to counterfeiting. In addition, drug counterfeiting poses a significant public health risk. Counterfeit drugs occur in various forms. Some are batches of completely fake drugs, and others are diluted drugs relabeled as higher priced products. Vast price disparities from one country to another combined with international free trade agreements make the U.S. supply chain particularly vulnerable to counterfeit drugs.

Drugs that are “serialized,” i.e., marked or otherwise associated with a unique serial number or other identifier, are easier to authenticate, track and trace as they move through the supply chain. One way to serialize each drug unit is in accordance with the Electronic Product Code (EPC) standard adopted by EPC global.

In accordance with one or more embodiments of the invention, the EPC or other serialization can be implemented along with a tracking mechanism such as, e.g., radio frequency identification technology (RFID), which can efficiently track drugs during shipping and receiving without manual scanning. The chain of custody system provides a secure, authentic, electronic chain of custody for each item to help safeguard the drug supply chain against counterfeits. The chain of custody system can link to product databases providing details for physical authentication of each unique drug product, thereby increasing drug control and safety, while protecting the brand of a drug manufacturer. The system can electronically track the drug's movement in the open supply chain from one custodian to the next. In the event of a recall or counterfeit incident, the chain of custody system also provides a rapid and accurate trace of all the custodians of the drug, which can significantly reduce time for making a recall, e.g., from weeks to hours.

The chain of custody system thereby provides an “electronic pedigree” for an item that significantly decreases the potential of a wholesaler or pharmacist to receive counterfeit drugs. Using the system, the pharmaceutical supply chain can cost effectively implement more effective pedigrees for drug products. RFID technology can improve accuracy in receiving and shipping operations, while decreasing labor time and costs for recalls and returns. The system can provide brand value protection, reduced shrink (i.e., inventory losses), more precise recalls at lower cost, and more accurate returns and reimbursements. The result is a safer drug supply chain that is also more cost-effective and time-efficient.

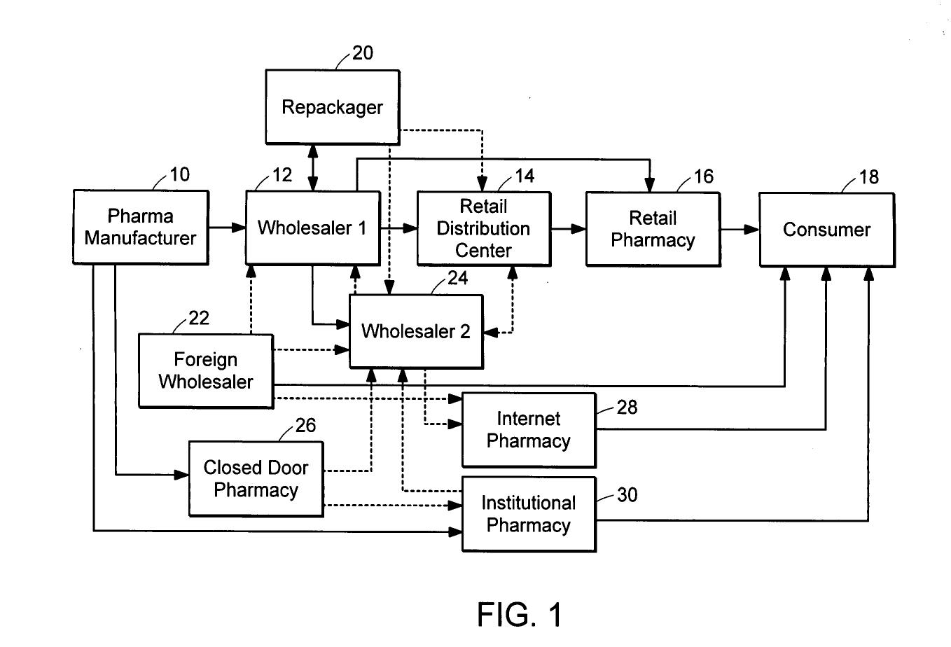

The pharmaceutical supply chain in the U.S. is generally complex. A simplified example of a supply chain is shown in FIG. 1. In this drawing, a direct distribution path is shown at unshaded blocks 10-18. Points of entry to the chain of potential counterfeit drugs are shown in the shaded blocks 20-30. Produced in bulk by the manufacturer, many drugs are repackaged into manageable quantities by authorized wholesalers and repackagers before shipment to retail pharmacies and health care institutions.

With price disparities and supply fluctuations, a drug may pass through numerous secondary wholesalers and distributors (sometimes as many as eight or ten) before reaching the pharmacist who dispenses it to the consumer. Many entities provide legitimate services such as closed door pharmacies who supply deeply discounted drugs to Medicaid and hospice patients.

One point of potential vulnerability in the drug supply chain is the Foreign Wholesaler 22 in FIG. 1. Strict laws control drug importation and re-importation. Yet counterfeit drugs can bypass understaffed regulators. In some cases, the origin of an imported drug is unknown. It may be a safe drug from a legitimate pharmaceutical manufacturer, or made in a garage.

In addition, legal personal purchases from foreign suppliers may be illegally aggregated and reintroduced into the legitimate supply chain.

Furthermore, unscrupulous wholesalers or repackagers 20 may combine counterfeit with authentic drugs.

Some pharmacies provide pharmaceuticals to a selected audience, such as HIV/AIDS patients or the elderly. These are called “closed door pharmacies” 26. While many closed door pharmacies lawfully sell deeply discounted drugs to patients in hospices and nursing homes, others divert the drugs at full price to secondary wholesalers. Diversion is also a way for diluted or adulterated drugs to enter the legitimate drug supply.

When counterfeit drugs find their way into the legitimate distribution chain, they endanger patients and impact the whole industry. Pharmaceutical manufacturers lose millions when counterfeiting tarnishes the reputation of a trusted brand, and when their authentic drugs are diverted by profiteers. At the receiving end of the drug supply chain, retail, institutional and Internet pharmacies are concerned with providing safe drugs to their patients.

In accordance with one or more embodiments of the invention, an EPC serial number is stored on an RFID tag, which is a tiny computer chip, and the EPC/RFID tag is attached to each drug product unit. This makes it possible to easily track every individual drug unit as it moves through the supply chain.

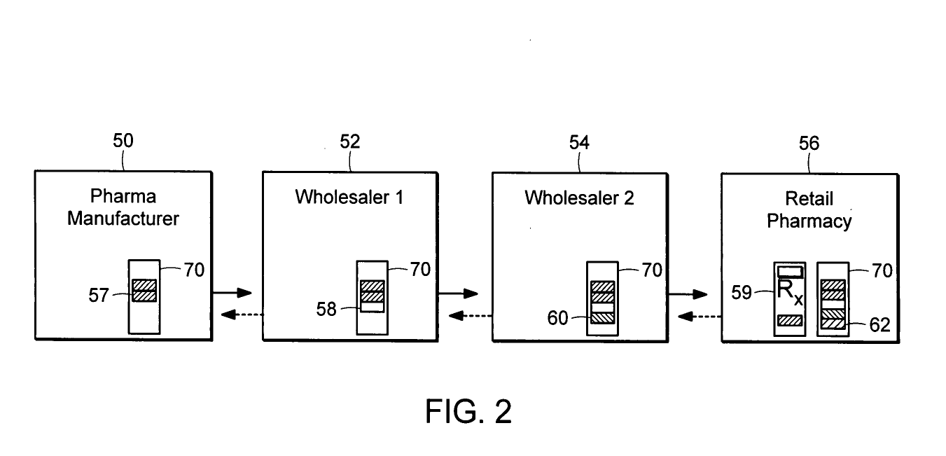

FIG. 2 shows how a chain of custody system in accordance with one or more embodiments of the invention can be used to track each drug. When the drug moves through the illustrated exemplary supply chain, the electronic pedigree grows as each successive custodian's information on its handling of the product is added. Each custodian signs the pedigree, creating an ever-growing record of each transaction that is trusted and secure. In accordance with one or more embodiments, digital signature technology can be used to authenticate and retrieve information and secure data encryption via the Secure Sockets Layer (SSL) protocol standard.

Each time the drug product changes ownership, the new custodian should authenticate the drug, its EPC serial number, and its custodian history, or pedigree. The authentication process includes verifying the drug is in fact what was ordered and also confirming the anti-counterfeit and tamper-evident measures.

The authentication and pedigree tracking process may occur when the products are received. Sellers may be required to provide the authentication and pedigree details about each drug product in advance, which gives the receiving custodian time to check the pedigree and EPC for each drug before the transaction.

As shown in FIG. 2, the drug manufacturer 50 can pre-position advance pedigree information 57 and EPCs to be expected on the electronic form 70 and forward the form 70 to wholesaler 52.

Wholesaler 52 can authenticate the electronic form 70 and EPC that it describes prior to receiving the item.

The manufacturer 50 receives confirmation of authentication and ships the item to the wholesaler 52. (It should be noted that this confirmation need not be a precondition to the shipping.) The wholesaler 52 adds details to the form as indicated by added section 58 of the form.

The wholesaler 52 can pre-position advance pedigrees for a combination of products, and then ship to wholesaler 54.

Wholesaler 54 adds details to the pedigree as indicated by added section 60 of the form.

The drug item eventually reaches a retail pharmacist 56, whose details are added to the pedigree as indicated by added section 62 of the form. When dispensing the drug 59, the pharmacist can track the scripts dispensed to each customer and retain the association with the EPC serial number.

In the event of a recall or counterfeit incident, the electronic pedigree identifies all prior transactions and custodians of this drug product unit, enabling rapid investigation of potential points of compromise. A drug information trace is shown, e.g., along the dashed arrows in FIG. 2.

The electronic pedigree trace of each serialized EPC can provide regulators with a robust analysis tool to quickly identify potential vulnerability points and alert affected custodians—wholesalers, pharmacists and consumers. If a trace indicates the problem occurred at a specific custodian, then the FDA could notify all owners of other drugs handled by that custodian in the same timeframe and/or by the same worker. The tracing process in accordance with one or more embodiments of the invention can help authorities quickly notify with pinpoint accuracy the custodians and consumers who may be affected, while avoiding alarming the general public. With an electronic pedigree based on serialized EPCs, the recall timeframe can be significantly reduced, e.g., from weeks to hours.

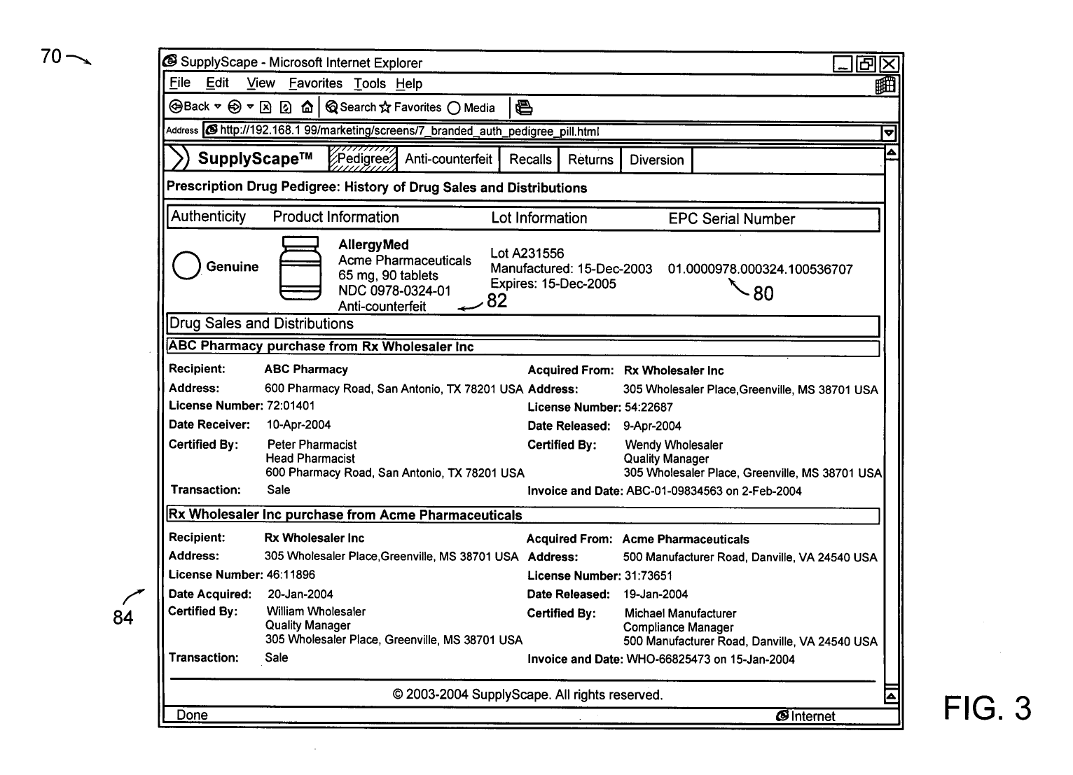

FIG. 3 is an exemplary screenshot of an electronic pedigree in accordance with one or more embodiments of the invention. The electronic pedigree serializes each drug product to provide identity authentication based preferably on the EPC standard as indicated at 80.

The Electronic Pedigree can include an “Anti-counterfeit measures” link 82 to product databases on a network providing details for physical authentication of each unique drug product, thereby increasing drug control and safety while protecting the brand. Physical authentication can include overt and covert anti-counterfeit and anti-tamper measures.

The electronic pedigree can track the drug's movement from one custodian to the next using information on the custodians as indicated, e.g., at 84.

In the event of a recall or counterfeit incident, the electronic pedigree can provide a rapid and accurate trace of all the custodians of the drug. Tracing this drug's custodians enables public safety authorities to quickly identify other drug products that may be similarly affected.

The electronic pedigree enables drug authentication, drug tracking, and drug tracing in an open supply chain preferably using the EPC standard. The robust pedigree application enables two-way information analysis for tracking the drug product as it moves forward in the supply chain, and for tracing a return, recall, or counterfeit investigation back to the source, regardless of where it occurs between the manufacturer and the consumer.

With a chain of custody system in accordance with one or more embodiments of the invention, overt authentication measures (e.g., the anti counterfeit measures link 82) can be linked to each EPC's Electronic Pedigree for rapid access. Even when authentication measures are changed to thwart counterfeiters, drugs with former authentication measures can still be verified since the electronic pedigree EPC can provide association to the historical information.

When pharmaceuticals are repackaged, the electronic pedigree can track the parent/child genealogy. Because bulk repackagers typically change the package, new EPC serial numbers are assigned for each new package. The bulk EPC can be retired, but information about this bulk EPC is retained for track and trace purposes.

Repackaging can be tracked regardless of where it occurs—at the pharmacy, wholesaler, repackager, or manufacturer.

By tracking the EPC genealogy, the electronic pedigree can make it possible to trace a drug from the point of dispensation all the way back to bulk manufacturing. In the event of a recall or counterfeit incident, if the trace indicates the problem occurred during repackaging, then authorities could notify all owners of drugs repackaged from the same parent EPC, or if warranted, different drugs repackaged at the same facility in the same timeframe.

For many custodians, the data capture process for EPC serial numbers can occur during shipping and receiving operations. The chain of custody system can authenticate the EPC identity of every drug product and can alert the shipping/receiving worker to exceptions based on each company's own business rules and operating procedures. The chain of custody system can streamline receiving via the Advance Pedigree Notice, which the shipping custodian sends in advance. The receiving entity analyzes and authenticates the drug pedigrees in the Advance Pedigree Notice before approving shipment. Then, when the drugs arrive in receiving, the EPCs on the drugs are verified against the Advance Pedigree Notice. Discrepancies can be flagged immediately.

### EXAMPLE 2

### Food Industry

Public health is threatened by food-borne diseases such as, e.g., mad cow disease (BSE), and improper food handling including lax temperature and expiration date control. A chain of custody system in accordance with one or more embodiments of the invention can provide secure and cost-effective mass serialization and tracking of animals, premises, and food products. In addition, the chain of custody system can provide precise and rapid traceability through the food chain.

### EXAMPLE 3

### Homeland Security—Safe Imports

A chain of custody system in accordance with one or more embodiments of the invention can expedite cargo clearance and reduce examinations needed by U.S. Customs, while increasing cargo security and visibility as required by Customs Trade Partnership Against Terrorism (C-TPAT), Free and Secure Trade Program (FAST), and Required Advance Electronic Presentation of Cargo Information. A chain of custody system can precisely track cargo from manufacturer to customs inspection, and enable companies to cost-effectively provide detailed electronic records to Customs demonstrating cargo security prior to and during shipment and increases supply chain security against terrorism and unmanifested material.

### EXAMPLE 4

### Defense Logistics

A chain of custody system in accordance with one or more embodiments of the invention can enable the U.S. Department of Defense and its suppliers to quickly and efficiently process large volumes of serialized materiel and supplies, freeing personnel for reassignment and streamlining DoD business processes. It can enable rapid and accurate tracking of the life history of each asset—each part as well as the vehicles and equipment awaiting the parts. With this information, the DoD can automatically and accurately track repairs and usage histories including knowing the duration and under what conditions the equipment has been utilized.

### EXAMPLE 5

### Medical Devices and Supplies

A chain of custody system in accordance with one or more embodiments of the invention can be used for the tracking of medical devices and supplies. Precise tracking is important for rapid and cost-effective provision, reverse logistics, replenishment and accurate settlement of vendor managed inventory (VMI), consignment and kitting. Government regulations can require precise tracking of product expiration dates. A chain of custody system in accordance with one or more embodiments of the invention can enable manufacturers and wholesale distributors to provide health care institutions with the right medical devices and supplies at the right locations at the right time.

### EXAMPLE 6

### Electronics, Software and Music

A chain of custody system in accordance with one or more embodiments of the invention can be used in the electronics, software and music industries for authenticating and tracing high-value products with small footprints to reduce losses from counterfeiting, grey market, shrinkage and inappropriate returns. The chain of custody system can reduce the cost and complexity of managing inventory comprised of multiple product versions and components that typically characterize the electronics and software industries.

The chain of custody system in accordance with various embodiments of the invention is preferably implemented in software. Accordingly, one of the preferred implementations of the invention is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

1. A system for maintaining a chain of custody record for the handling of an item transferred among a plurality of custodians, comprising:
(a) a plurality of computers, each operable by one of said plurality of custodians; and
(b) an electronic form transferable among said computers, said form being successively transferred from a computer operated by one custodian to a computer operated by another in correspondence with the successive transfer of said item from said one custodian to said another, said form identifying said item and including space for entry of information by each custodian handling said item, said information including an identification of said custodian and a digital signature of said custodian authenticating said item, and wherein at least some of said information entered by a custodian is unalterable by another custodian receiving the form.

2. The system of claim 1 wherein said information further includes information on the context of the change in custody of said item.

3. The system of claim 1 wherein said item is identified in said electronic form by a serial number associated with said item.

4. The system of claim 1 wherein said item is identified in said electronic form by an EPC serial number associated with said item.

5. The system of claim 1 wherein said item is identified by an identifier that can be sensed using automatic data capture technologies.

6. The system of claim 1 wherein said item is identified by an identifier stored on an RFID tag secured with respect to said item.

7. The system of claim 1 wherein said item is identified by an identifier stored on bar code secured with respect to said item.

8. The system of claim 1 wherein said information further includes information on when the item was received by a custodian or sent by a custodian.

9. The system of claim 1 wherein said information further includes any changes made by a custodian to the item or to the packaging of said item.

10. The system of claim 1 wherein said information further includes information on the expected disposition of said item.

11. The system of claim 1 wherein said electronic form is transferable among said computers via a computer network.

12. The system of claim 1 wherein said item comprises a pharmaceutical product.

13. The system of claim 1 wherein said item comprises an item selected from the group consisting of a pharmaceutical product, cargo, a medical device, an electronics product, software and music products.

14. The system of claim 1 wherein said form further includes a link to a database on a network providing additional information on said item for use in authenticating said item.

15. A method of securely transferring an item by a first custodian of said item to a second custodian of said item, the method comprising:
(a) said first custodian entering information on the identity of said first custodian on an electronic form identifying said item;
(b) said first custodian digitally signing said electronic form to authenticate said item;
(c) said first custodian transmitting said electronic form to said second custodian; and
(d) said first custodian sending said item to said second custodian.

16. The method of claim 15 wherein transmitting said electronic form comprises transmitting said electronic form from a computer operated by said first custodian to a computer operated by said second custodian over a computer network.

17. The method of claim 15 wherein at least some of said information entered by said first custodian is unalterable by said second custodian.

18. The method of claim 15 wherein said information further includes information on the context of the change in custody of said item.

19. The method of claim 15 wherein said item is identified in said electronic form by a serial number associated with said item.

20. The method of claim 15 wherein said item is identified in said electronic form by an EPC serial number associated with said item.

21. The method of claim 15 wherein said item is identified by an identifier stored on an RFID tag secured with respect to said item.

22. The method of claim 15 wherein said item is identified by an identifier that can be sensed using automatic data capture technologies.

23. The method of claim 15 wherein said item is identified by an identifier stored on bar code secured with respect to said item.

24. The method of claim 15 wherein said information further includes information on when the item was received by a custodian or sent by a custodian.

25. The method of claim 15 wherein said information further includes any changes made by a custodian to the item or to the packaging of said item.

26. The method of claim 15 wherein said information further includes information on the expected disposition of said item.

27. The method of claim 15 wherein said item comprises a pharmaceutical product.

28. The method of claim 15 wherein said item comprises an item selected from the group consisting of a pharmaceutical product, cargo, a medical device, an electronics product, software and music products.

29. An electronic form for facilitating the transfer of an item among a plurality of custodians, said form being successively transferable from a computer operated by one custodian to a computer operated by another in correspondence with the successive transfer of said item from said one custodian to said another, said form comprising:
an identification of said item; and
a space for entry of information by each custodian handling said item, said information including an identification of said custodian and a digital signature of said custodian authenticating said item, and wherein at least some of said information entered by one custodian is unalterable by another custodian receiving the form.

30. The electronic form of claim 29 wherein said identification of said item comprises a serial number associated with said item.

31. The electronic form of claim 29 wherein said identification of said item comprises an identifier that can be sensed using automatic data capture technologies.

32. The electronic form of claim 29 wherein said identification of said item comprises an EPC serial number associated with said item.

33. The electronic form of claim 29 wherein said identification of said item comprises an identifier stored on an RFID tag secured with respect to said item.

34. The electronic form of claim 29 wherein said identification of said item comprises an identifier stored on bar code secured with respect to said item.

35. The electronic form of claim 29 wherein said information further includes information on when the item was received by a custodian or sent by a custodian.

36. The electronic form of claim 29 wherein said information further includes information on the context of the change in custody of said item.

37. The electronic form of claim 29 wherein said information further includes information on the expected disposition of said item.

38. The electronic form of claim 29 wherein said information further includes any changes made by a custodian to the item or to the packaging of said item.

39. The electronic form of claim 29 wherein said electronic form is transferable among said computers via a computer network.

40. The electronic form of claim 29 wherein said item comprises a pharmaceutical product.

41. The electronic form of claim 29 wherein said item comprises an item selected from the group consisting of a pharmaceutical product, cargo, a medical device, an electronics product, software and music products.

42. The electronic form of claim 29 wherein said form further includes a link to a database on a network providing additional information on said item for use in authenticating said item.
